(19) United States
(12) Patent Application Publication
(10) Pub. No.: US 2021/0215104 A1
(43) Pub. Date: Jul. 15, 2021

(54) METHOD AND SYSTEM FOR CONTROLLING OPERATION OF AN ENGINE USING AN ENGINE CONTROLLER

(71) Applicant: PRATT & WHITNEY CANADA CORP., Longueuil (CA)

(72) Inventors: Michael DARBY, Candiac (CA); Mohammad Khashayar Donyaee, Ellicott City, MD (US); Teuvo Saario, Longueuil (CA); Frederic Giroux, Longueuil (CA)

(21) Appl. No.: 16/743,681

(22) Filed: Jan. 15, 2020

(51) Int. Cl. F02C 9/00; F02C 7/26

(52) U.S. Cl. CPC F02C 9/00; F05D 2220/323; F02C 7/26

(57) ABSTRACT

Systems and methods for controlling operation of an engine using an engine controller are described herein. A status of the controller is set at an initial state. Pilot input for control of the engine is received and one or more engine parameters are obtained. The status of the controller is updated according to engine specific requirements based on at least one of the pilot input and the one or more engine parameters. The engine specific requirements defining conditions for transitioning the status of the controller for the engine. Operation of the engine is controlled based on the status of the controller, the pilot input, and the one or more engine parameters.

### TECHNICAL FIELD

The present disclosure relates generally to engine control, and, more particularly, to methods and systems for controlling operation of an engine using an engine controller.

### BACKGROUND OF THE ART

Engine controllers may be separately designed according to different engine types and/or models. This may require significant time and/or cost to develop and/or test the engine controllers. As such, there is room for improvement.

### SUMMARY

In one aspect, there is provided a method for controlling operation of an engine using an engine controller. The method comprises setting a status of the controller at an initial state, receiving pilot input for control of the engine and obtaining one or more engine parameters, updating the status of the controller according to engine specific requirements based on at least one of the pilot input and the one or more engine parameters, the engine specific requirements defining conditions for transitioning the status of the controller for the engine, and controlling operation of the engine based on the status of the controller, the pilot input, and the one or more engine parameters.

In another aspect, there is provided a system for controlling operation of an engine using an engine controller. The system comprises a processing unit and a non-transitory memory communicatively coupled to the processing unit and comprising computer-readable program instructions. The program instructions are executable by the processing unit for setting a status of the controller at an initial state, receiving pilot input for control of the engine and obtaining one or more engine parameters, updating the status of the controller according to engine specific requirements based on at least one of the pilot input and the one or more engine parameters, the engine specific requirements defining conditions for transitioning the status of the controller for the engine, and controlling operation of the engine based on the status of the controller, the pilot input, and the one or more engine parameters.

### DESCRIPTION OF THE DRAWINGS

Reference is now made to the accompanying figures in which:

FIG. 1 is a schematic cross-sectional view of an example gas turbine engine, in accordance with one or more embodiments;

FIG. 2 is a schematic of an example system for controlling operation of an engine using an engine controller, in accordance with one or more embodiments;

FIG. 3 is a block diagram of control logic of an engine controller, in accordance with one or more embodiments;

FIG. 4 is an example of a state machine, in accordance with one or more embodiments;

FIG. 5 is a flowchart illustrating an example method for controlling operation of an engine using an engine controller, in accordance with one or more embodiments;

FIG. 6 is a flowchart illustrating an example for synchronizing the status of a controller between an active and a passive channel, in accordance with one or more embodiments;

FIG. 7 is timing diagram illustrating a channel switchover, in accordance with one or more embodiments;

FIG. 8 is a flowchart illustrating another example for synchronizing the status of a controller between an active and a passive channel, in accordance with one or more embodiments; and

FIG. 9 is an example computing device, in accordance with one or more embodiments.

It will be noted that throughout the appended drawings, like features are identified by like reference numerals.

### DETAILED DESCRIPTION

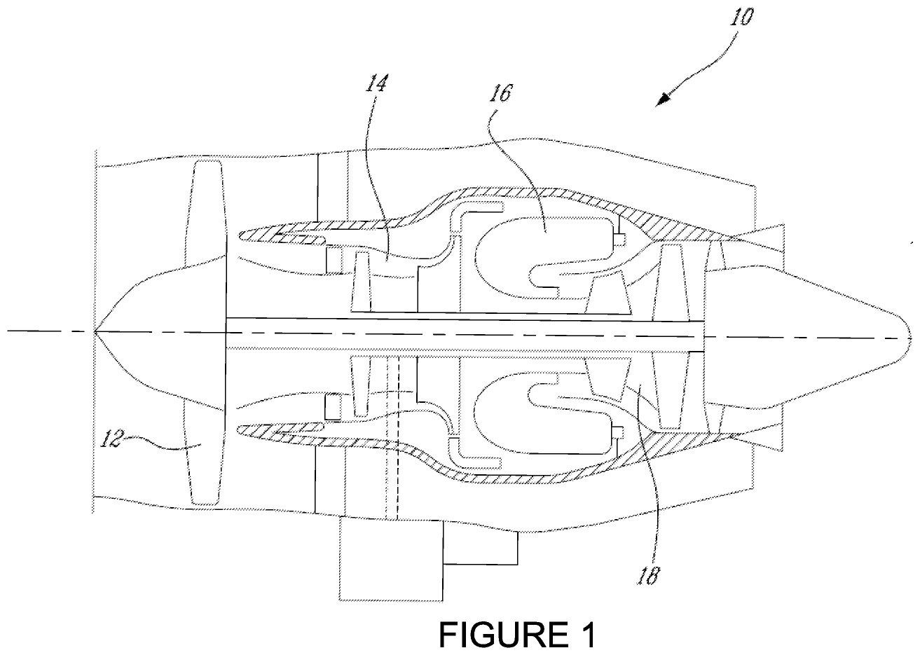

FIG. 1 illustrates a gas turbine engine 10, which operation may be controlled with the systems and methods described herein. The engine 10 generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. Note that while engine 10 is a turbofan engine, the systems and methods for controlling operation of an engine using an engine controller may be applicable to turboprop engines, turboshaft engines, or other suitable types of engine.

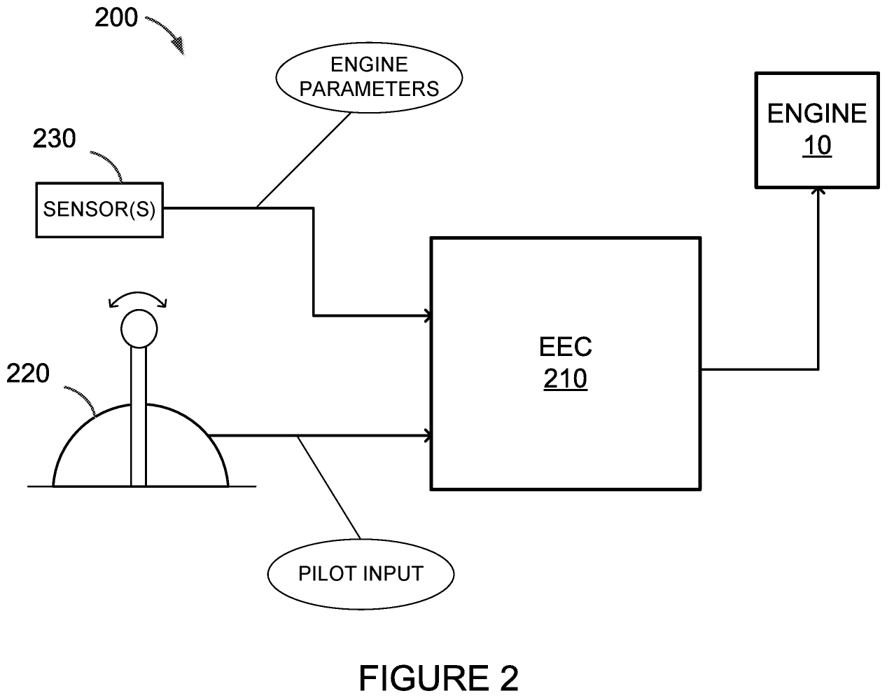

With reference to FIG. 2, a system 200 for controlling operation of an engine, such as the engine 10, is illustrated. The system 200 comprises an electronic engine controller (EEC) 210. The EEC 210 is configured to monitor a controller status. When the EEC 210 is powered on, the controller status may be set at an initial state. The EEC 210 receives pilot input and obtains one or more engine parameters. The controller status is updated according to engine specific requirements based on at least one of the pilot input and the one or more engine parameters. The engine specific requirement defines conditions for transitioning the controller status for the engine 10. The EEC 210 controls operation of the engine 10 based on the controller status, the pilot input and the one or more engine parameters.

The pilot input may be received from one or more control mechanisms 220. While the control mechanism 220 is illustrated as a power lever in FIG. 2, this is for example purposes only. Any suitable control mechanism may be used. The control mechanism(s) 220 may comprise one or more control mechanisms provided in the cockpit of the aircraft. The control mechanism(s) 220 may comprise any one or more of a mechanical lever, a push button, an electrical switch, an electronic interface, any suitable actuator and the like. The control mechanism(s) 220 may be for any one or more of requesting start of the engine 10, requesting shutdown of the engine 10, controlling operation of the engine 10 once started and the like. The control mechanism(s) 220 may be part of the system 200 or separate from the system 200.

The engine parameters may be obtained in any suitable manner. The engine parameters may be obtained from one or more sensors 230 connected to the EEC 210. While the sensor(s) 230 are shown separate from the engine 10 this is for example purposes only. The sensor(s) 230 may be any suitable sensors for measuring one or more engine parameters. One or more of the sensors 230 may be engine sensors coupled to the engine 10. One or more of the sensors 230 may be aircraft sensors coupled to the aircraft. The sensor(s) 230 may be part of the system 200 or may be separate from the system 200. The engine parameters may be continuously received (e.g., in real time) and/or may be received in accordance with any suitable time interval or irregularly. Additionally or alternatively, the engine parameters may be provided by one or more aircraft or/and engine computers and/or by any other suitable intermediary device(s). The aircraft and/or engine computer and/or intermediary device(s) may be configured for obtaining the engine parameters from the sensor(s) 230. In some embodiments, one or more of the engine parameters may be generated by the EEC 210 based on measured engine parameter(s). The engine parameter(s) may comprise any one or more of: engine speed, engine temperature, interstage turbine temperature (ITT), generator speed (N1), compressor speed (Ng), power turbine speed (N2), rotor speed, fuel flow (WF), oil pressure, oil temperature, air speed, ambient temperature, outside air temperature (OAT) or static air temperature, total ambient atmospheric temperature, total ambient atmospheric pressure, altitude, exhaust pressure, bleed flow, bleed pressure, bleed temperature, accessories loads and/or any other suitable engine parameters. While the EEC 210 is illustrated as separate from the engine 10, in some embodiments, the EEC 210 may be provided as part of the engine 10 and/or coupled to the engine 10.

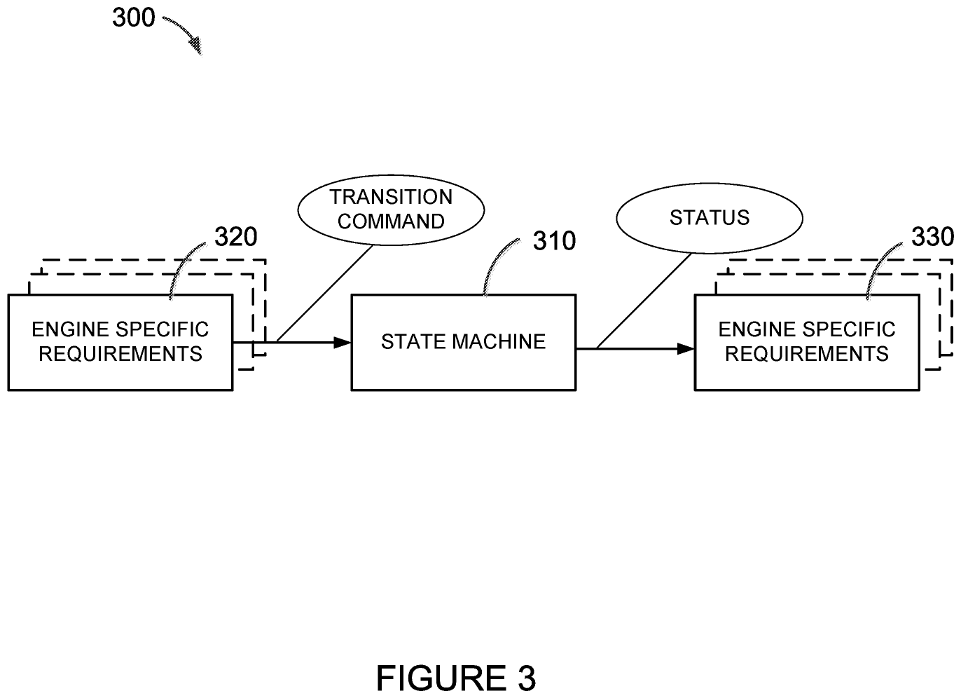

With reference to FIG. 3, a block diagram of control logic 300 for the EEC 210 is illustrated. A state machine 310 may be used for monitoring the controller status. Any other suitable controller logic may be used for monitoring the controller status. The EEC 210 may be programmed with the engine specific requirements 320, 330. The engine specific requirements 320 corresponds to the input to determine the controller status and the engine specific requirements 330 corresponds to the output that uses the controller status. In some embodiments, the EEC 210 may be programmed with multiple different engine specific requirements 320, 330 and one or more of the engine specific requirements 320, 330 may be selected that is specific to the engine 10 and/or the installation of the engine 10. For example, a given one of the engine specific requirements 320, 330 may correspond to the engine specific requirements for a particular type of engine and/or a particular engine model. Accordingly, the engine specific requirements 320, 330 of the EEC 210 may be specific to one or more of: the engine model, the engine type, and the engine installation. The EEC 210 may determine a transition command from the engine specific requirements 320 based on at least one of the pilot input and the engine parameter(s). Accordingly, the engine specific requirements 320 may specify which inputs (e.g., the pilot input and/or which ones of the engine parameters) to use and any levels and/or threshold used to determine a given transition command. By way of example, the transition command may corresponds to one of: a start command, a shutdown command, a start complete command, a shutdown complete command, and an engine testing command. The transition commands may vary depending on practical implementations. For example, additional transition commands may be added to aforementioned list and/or one or more of the aforementioned transition commands may be omitted. The transition command may be provided to the state machine 310, which sets the controller status based on the transition command. The state machine 310 may output the controller status. For example, the controller status may corresponds to one of: engine off, engine starting, engine running, engine shutting down and engine testing. The controller status may vary depending on practical implementations. For example, additional statuses may be added to aforementioned list and/or one or more of the aforementioned statuses may be omitted. The engine specific requirements 330 may specify how to control operation of the engine based on the controller status, pilot input, and/or engine parameter(s). Accordingly, the EEC 210 may determine one or more engine control commands for controlling operation of the engine 10 from the engine specific requirements 330 based on the controller status, the pilot input and the engine parameter(s). The EEC 210 may control operation of the engine 10 based on the one or more engine control commands. It should be appreciated that multiple input parameters may be consolidated into a given controller status and this may standardized and/or simplify the use of those parameters in the engine specific requirements 330 used to control operations. This consolidation may also increase the safety of the engine operation, for example, using controllers statuses may prevent wrong operations in some specific controller statuses and/or may prevent programming mistakes in the engine specific requirements 330.

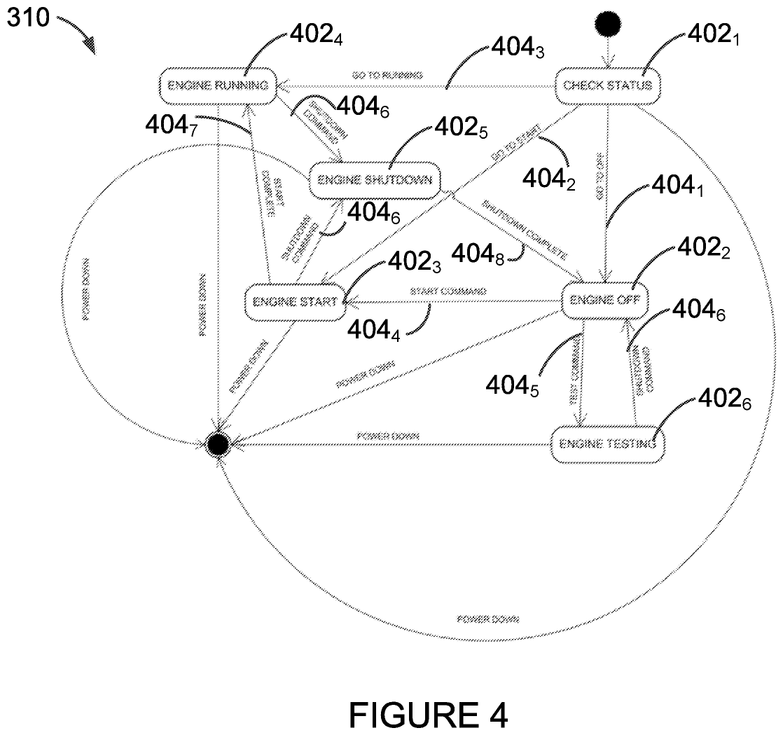

With reference to FIG. 4, a specific and non-limiting example of the state machine 310 is illustrated. The state machine 310 comprises a plurality of controller states 402₁ to 402₆ (collectively “402”) indicative of operating modes of the controller 210. The controller status may correspond to one of the controller states 402. The terms “controller status” and “controller state” may be interchanged with each other. Each one of the controller states 402 is associated with at least one of the transitions 404₁ to 404₈ (collectively “404”). Each one of the transitions 404 may be associated with a given one of the transition commands. For example, each one of the transitions 404 may correspond to a given one of the transition commands. In the example of FIG. 4, the controller states 402 corresponds to a check status state 402₁, engine off state 402₂, engine starting state 402₃, engine running state 402₄, engine shutting down state 402₅ and engine testing state 402₆. When the EEC 210 is powered on, the controller status is initially set at the check status state 402₁. Similarly, when the EEC 210 has two channels and the EEC 210 is powered on, each channel may be set at the check status state 402₁. In some embodiments, when the EEC 210 has two channels, and one of the channels is active and the other is passive, the active channel may set the controller status of the active channel at the check status state 402₁ and the passive channel may receive the controller status from the active channel. The passive channel may then set the controller status of the passive channel based on the received controller status.

In the example of FIG. 4, when in the check status state 402₁, the state machine 310 awaits one of a go to off command 404₁, go to start command 404₂ or go to running command 404₃. When in the check status state 402₁, the EEC 210 may determine the transition command from the engine specific requirements 320 based on the engine parameter(s). For example, the EEC 210 may determine the transition command as one of go to off command 404₁, go to start command 404₂ and go to running command 404₃ based on engine rotational speed. When the state machine 310 receives the go to off command 404₁, the controller state transitions from the check status state 402₁ to the engine running state 402₄. When the state machine 310 receives the go to start command 404₂, the controller state transitions from the check status 402₁ state to the engine start state 402₃. When the state machine 310 receives the go to running command 404₃, the controller state transitions from the check status state 402₁ to the engine running state 402₄.

When in the engine off state 402₂, the engine running state 402₄, or engine testing state 402₆, the EEC 210 may determine the transition command from the engine specific requirements 320 based on the pilot input. The pilot input may be any one of a start command, a shutdown command, and an engine test command. The pilot input may correspond to the transition command. The EEC 210 may determine the transition command as one a start command 404₄, a shutdown command 404₅, or an engine test command 404₆ based on the pilot input. When in the engine off state 402₂ and the state machine 310 receives a start command 404₄, the controller state transitions to the engine starting state 402₃. When in the engine off state 402₂ and the state machine 310 receives an engine test command 404₅, the controller state transitions to the engine testing state 402₆. When in the engine running state 402₄ and the state machine 310 receives the shutdown command 404₆, the state machine 310 transitions to the engine shutting down state 402₅. When in the engine testing state 402₆ and the state machine 310 receives the shutdown command 404₆, the state machine 310 transitions to the engine off state 402₆.

When in the engine starting state 402₃, or engine shutting down state 402₅, the EEC 210 may determine the transition command from the engine specific requirements 320 based on the engine parameter(s) and/or pilot input. For example, the EEC 210 may determine the transition command as one of a start complete command 404₇ or a shutdown complete command 404₈ based on engine rotational speed. By way of another example, the EEC 210 may determine the transition command as the shutdown command 404₆ based on pilot input. When in the engine starting state 402₃ and the state machine 310 receives the shutdown command 404₆, the state machine 310 transitions to the engine shutting down state 402₅. When in the engine starting state 402₃ and the state machine 310 receives the start complete command 404₇, the state machine 310 transitions to the engine running state 402₄. When in the engine shutting down state 402₅ and the state machine 310 receives the shutdown complete command 404₈, the state machine 310 transitions to the engine off state 402₂. The state machine 310 may vary depending on practical implementations.

To further illustrate the operation of the EEC 210 and the state machine 310, a specific and non-limiting example of a sequence for an aircraft flight will now be described. The aircraft systems are powered on, including the EEC 210. The state machine 310 assumes an initial check status state 402₁. The EEC 210 determines that the engine speed is as zero and sends go to off command 404₁ to the state machine 310. The state machine 310 changes it state from the check status state 402₁ to the engine off state 402₂. When a pilot pushes an engine start button the EEC detects the pilot input and sends the start command 404₄ to the state machine 310. The state machine 310 changes its state from the engine off state 402₂ to the engine starting state 402₃. The EEC 210 controls fuel and other effectors to start the engine 10 and bring it to idle. When the engine 10 is near idle, the EEC 210 determines that a start is over and sends the start complete command 404₇ to the state machine 310. The state machine 310 changes its state from the engine starting state 402₃ to the engine running state 402₄. The EEC 210 controls the fuel and other effectors to operate the engine 10 and modulate engine power according to pilot input, engine condition(s), and flight condition(s). When the flight is over the pilot pushes an engine stop button and the EEC 210 detects the pilot input and sends the engine shutdown command 404₆ to the state machine 310. The state machine 310 changes its state from the engine running state 402₄ to the engine shutting down state 402₅. The EEC 210 controls the fuel and other effectors to operate the engine through its shutdown sequence, ending with shutting off fuel. When the EEC 210 detects that the engine speed is as zero it sends shutdown complete command to the state machine 310. The state machine 310 changes it state from the engine shutting down state 402₅ to the engine off state 402₂.

A specific and non-limiting example of sequence for a maintenance procedure will now be described. The aircraft systems are powered on, including the EEC 210. The state machine 310 assumes an initial check status state 402₁. The EEC 210 determines that the engine speed is as zero and sends go to off command 404₁ to the state machine 310. The state machine 310 changes it state from the check status state 402₁ to the engine off state 402₂. When a pilot or maintenance technician issues a maintenance related command such as dry motoring, wet motoring, igniter check or other suitable maintenance command, the EEC 210 detects the command and sends a test command 404₅ to the state machine 310. The state machine changes its state from the engine off state 402₅ to the engine testing state 402₆. The EEC 210 may control fuel and other effectors as per the desired maintenance action but does not start the engine 10 nor run the engine 10. When the maintenance action(s) is/are complete the pilot or maintenance technician pushes the engine stop button and the EEC 210 detects the input and sends the shutdown command 404₆ to the state machine 310. The state machine 310 changes its state from engine testing state 402₆ to the engine off state 402₂.

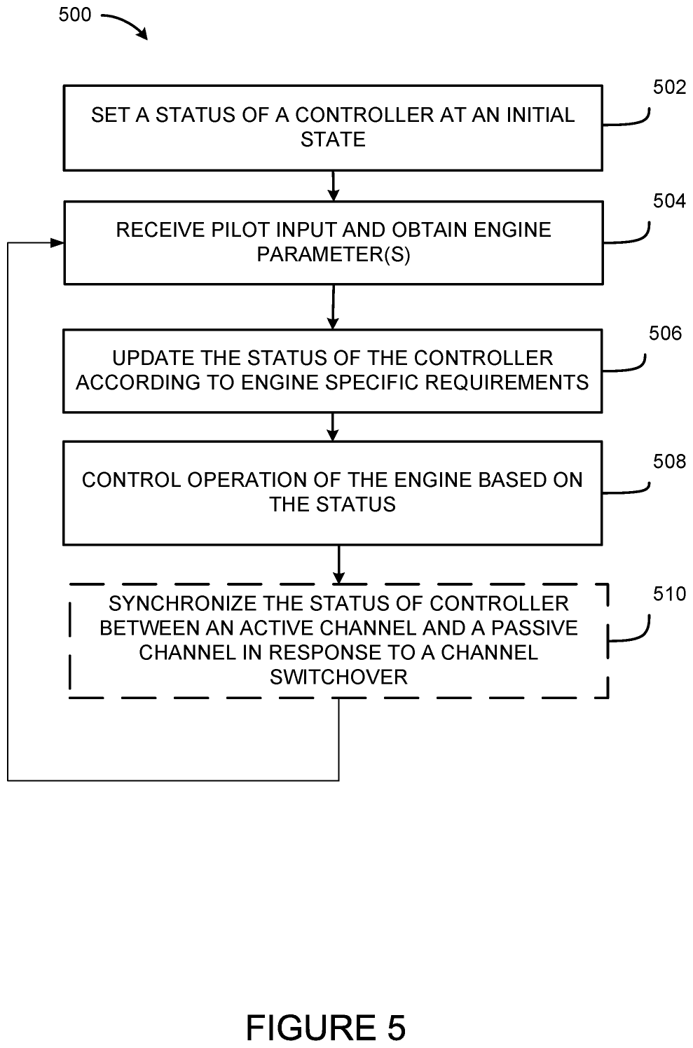

With reference to FIG. 5, there is shown a flowchart illustrating an example method 500 for controlling operation of an engine using an engine controller. The method 500 may be implemented using any suitable engine controller, such as the EEC 210, or may be implemented by any other suitable engine and/or aircraft computer. While the method 500 is described herein with reference to the engine 10, the EEC 210, the state machine 310, and the engine specific requirements 320, 330 this is for example purposes only.

At step 502, a status of the controller 210 is set at an initial state. The status of the controller 210 may be set at power on of the controller 210. The status may be set to the initial state in an active channel of the controller 210 and may be set in a passive channel of the controller 210. Both channels may set the status to the initial state at power on. Alternatively, the active channel may set the status to the initial state at power on, and provide the status to the passive channel which sets its status according to the received status, which in this case is the initial state. The active channel may provide the status of the controller to passive channel continuously (e.g., real-time) and/or in accordance with any suitable time interval or irregularly, and the passive channel may set its status according to the status received from the active channel. The initial state may be the check status state 402₁. The terms “status of the controller” and “state of the controller” may be interchanged with each other. Similarly, the terms “controller status” and “status of the controller” may be interchanged with each other.

At step 504, pilot input for control of the engine 10 is received and one or more engine parameters are obtained. The controller 210 may receive the pilot input and obtain the engine parameter(s) in any suitable manner.

At step 506, the status of the controller 210 is updated according to engine specific requirements 320 based on at least one of pilot input and the one or more engine parameters. The engine specification requirement 320 defines conditions for transitioning the status of the controller 210 for the engine 10. In some embodiments, updating the status of the controller 210 comprises determining a transition command from the engine specific requirements 320 based on at least one of the pilot input and the engine parameter(s), and setting the status in a state machine 310 of the controller 210 based on the transition command.

At step 508, operation of the engine 10 is controlled based on the status of the controller, the pilot input, and the one or more engine parameters. The operation of the engine 10 may be controlled in any suitable manner.

In some embodiments, the controller 210 is a dual channel redundant controller operating with an active channel and a passive channel. The method 500 may be performed in the active channel of the controller 210. The passive channel may receive the status of the active channel and set a status of the passive channel to the received status. In other words, the passive channel may output to status from the active channel. The passive channel may be waiting to assume control, becomes the active channel when needed, and perform the method 500. Accordingly, the two channel of the controller 210 may be running asynchronously.

In some embodiments, at step 510, the status of the controller 210 between the active channel and the passive channel is synchronized in response to a channel switchover. Step 510 may occur at any time during the performance of the method 500 in response to detecting that a channel switchover has occurred.

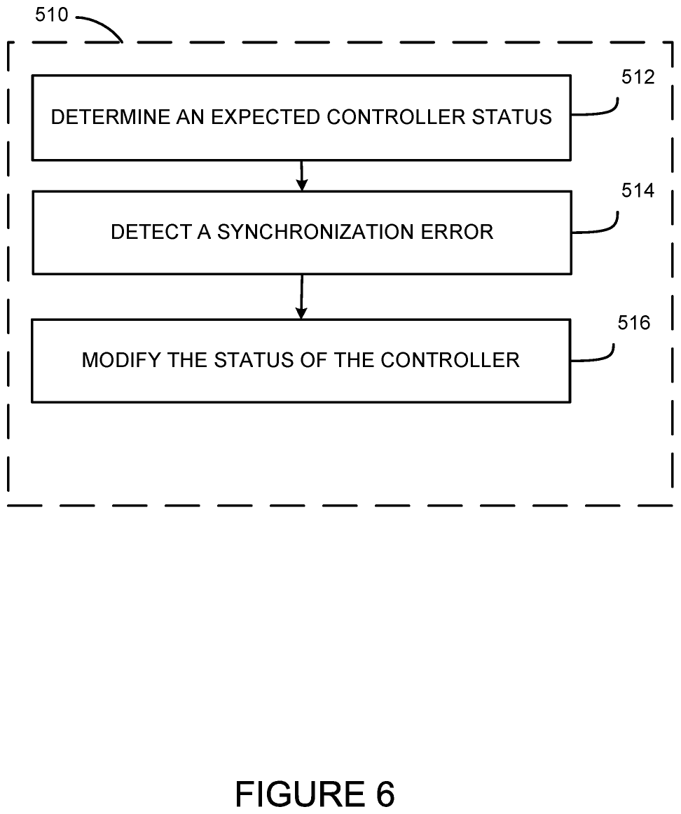

In some embodiments, synchronizing the status of the controller at step 510 may be implemented according to the steps shown in the flow chart of FIG. 6. At step 512, an expected controller status is determined. The expected controller status may be determined based on previously received pilot input. The expected controller status may be determined based on a previously received transition command. At step 514, a synchronization error is detected when the expected controller status differs from the status of the controller 210. Detecting the synchronization error may comprise detecting the synchronization error when the expected controller status differs from the status of the active channel and the expected controller status differs from the status of the passive channel. At step 516, the status of the controller 210 is modified in response to detecting the synchronization error. Modifying the status of the controller 210 may comprises setting the status of the controller 210 to the expected controller status. Modifying the status of the controller 210 may comprise setting the status of the active channel to the expected controller status or to the status of the passive channel.

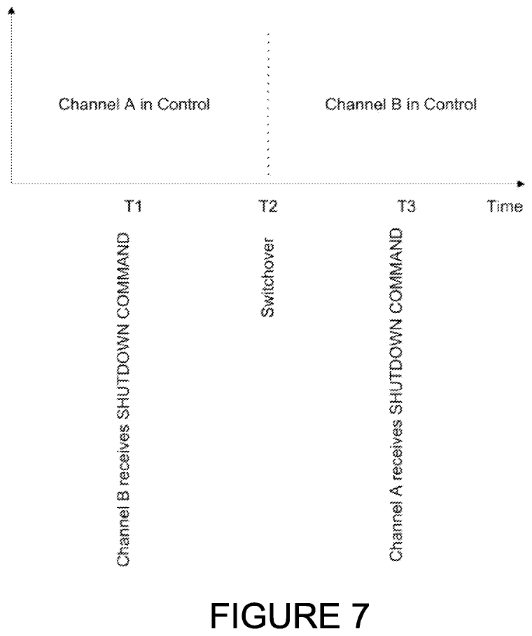

With additional reference to FIG. 7, a specific and non-limiting example illustrates synchronizing the status of the controller 210. As illustrated a first channel A of the controller 210 is initially the active channel, the status of the controller 210 is the engine running state 402₄, and a second channel B of the controller 210 is the passive channel. At time T1, channel B receives a shutdown command. At time T2, a channel switchover occurs and channel B becomes the active channel and channel A becomes the passive channel. At time T3, channel A receives the shutdown command. Accordingly, at step 512 of FIG. 6, channel B may determine after the channel switchover, that channel B previously received a shutdown command, and determine the expected controller status based on the previously received shutdown command. In this example, the expected controller status is the engine shutting down state 402₅. At step 514, a synchronization error is detect, as the status of the channel B is the engine running state 402₄ and the expected controller status is the engine shutting down state 402₅. At step 516, the status of the controller 210 is modified from the engine running state 402₄ to the engine shutting down state 402₅.

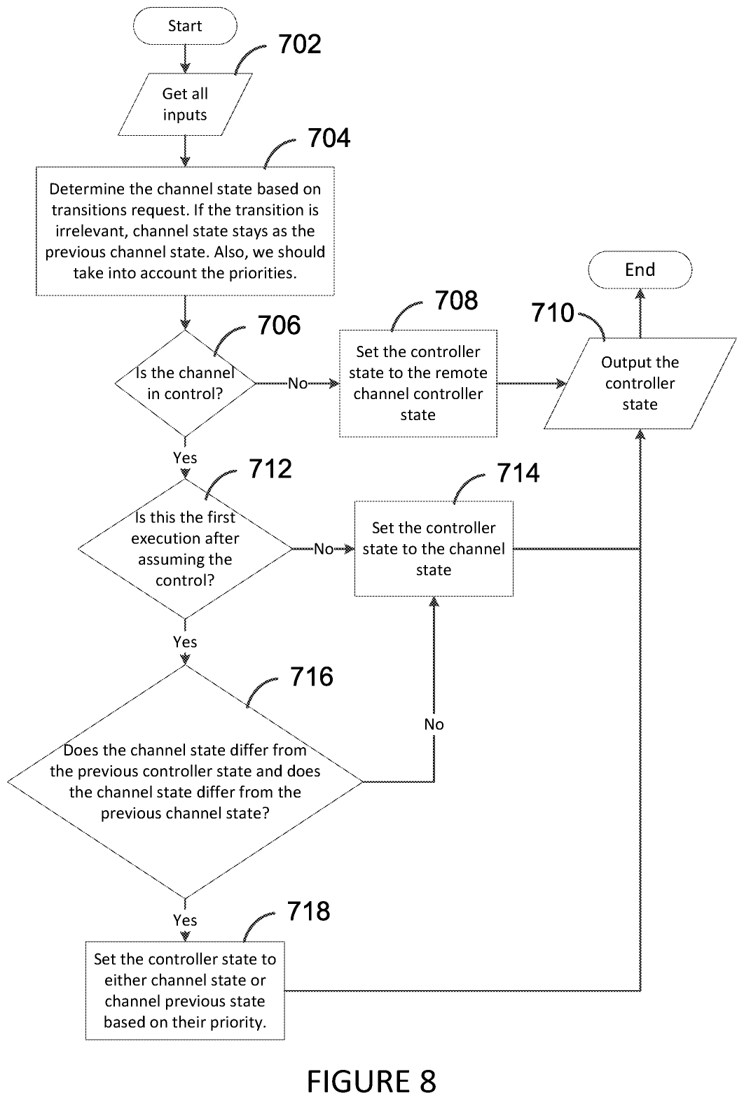

With reference to FIG. 8, another example illustrates the synchronization of the status of the controller 210. At step 702, the pilot input and the engine parameter(s) are obtained. At step 704, a channel status is determined based on the transition command. If the transition command is irrelevant (e.g., the transition command is a request to transition to the current state of the state machine 310), then the channel status remains unchanged. The controller states 402 may have priorities and the priorities may be considered at step 704 in determining if the transition command is irrelevant. For example, the engine running state 402₄ may have higher priority than the engine start state 402₃. Accordingly, if the transition command is to engine start state 402₃ from the engine running state 402₄, the transition command may be disregarded. At step 706, if the channel is in control (i.e., the channel is the active channel), then the next step is 712. Otherwise, if the channel is not in control (i.e., the channel is the passive channel), then the next step is 708. At step 708, the passive channel sets its status to status of the active channel, and at step 710, the channel outputs its status. At step 712, it is determined if the transition command is the first received command after a channel switchover. If it is the first received command after the channel switchover, then the next step is 714; otherwise, the next step is 716. At step 714, the status of controller is set to channel status as determined at step 704. At step 716, it is determined whether the channel status determined at step 704 differs from the previous status of the controller 210 and the channel status determined at step 704 differs from the previous channel status. If not, then the next step is 714; otherwise, the next step is 718. At step 718, the controller status is set to either the previous status of the controller 210 or the previous channel status the based on priorities of the statuses, and at step 710, the channel outputs its status.

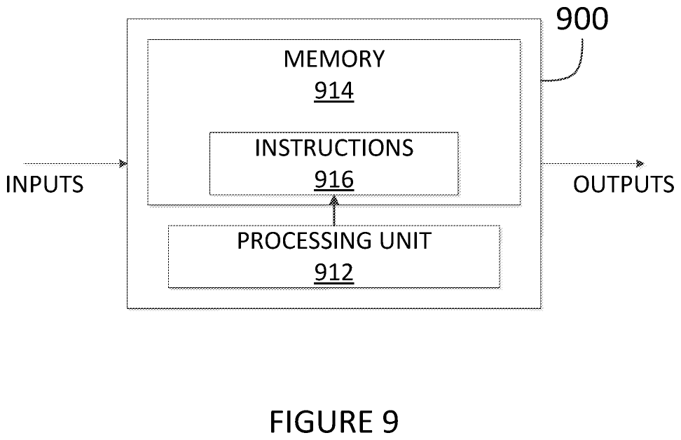

With reference to FIG. 9, the system 200 and/or the method 500 may be implemented using at least one computing device 900. For example, the EEC 210, may be implemented by at least one computing device 900. In some embodiments, each channel of the EEC 210 is implemented by at least one computing device 900. The computing device 900 comprises a processing unit 912 and a memory 914 which has stored therein computer-executable instructions 916. The processing unit 912 may comprise any suitable devices such that instructions 916, when executed by the computing device 900 or other programmable apparatus, may cause at least in part the functions/acts/steps of the method 500 as described herein to be executed. The processing unit 912 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 914 may comprise any suitable known or other machine-readable storage medium. The memory 914 may comprise non-transitory computer readable storage medium, for example, but not limited to, an electronic, magnetic, optical, electromagnetic, infrared, or semiconductor system, apparatus, or device, or any suitable combination of the foregoing. The memory 914 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 914 may comprise any storage means (e.g., devices) suitable for retrievably storing machine-readable instructions 916 executable by processing unit 912. In some embodiments, the computing device 900 can be implemented as part of a full-authority digital engine controls (FADEC) or other similar device, including an EEC, an engine control unit (ECU), and the like. In some embodiments, the EEC 210 is implemented by a FADEC.

The methods and systems for controlling operation of an engine using an engine controller described herein may be implemented in a high level procedural or object oriented programming or scripting language, or a combination thereof, to communicate with or assist in the operation of a computer system, for example the computing device 900. Alternatively, the methods and systems for controlling operation of an engine using an engine controller may be implemented in assembly or machine language. The language may be a compiled or interpreted language. Program code for implementing the methods and systems for controlling operation of an engine using an engine controller may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for controlling operation of an engine using an engine controller may also be considered to be implemented by way of a non-transitory computer-readable storage medium having a computer program stored thereon. The computer program may comprise computer-readable instructions which cause a computer, or in some embodiments the processing unit 912 of the computing device 900, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, the state machine 310 may be interchanged with any other suitable logic for monitoring the controller status. By way of another example, the EEC 210 may be interchanged with any suitable engine controller or any suitable engine and/or aircraft computer. Yet further modifications could be implemented by a person of ordinary skill in the art in view of the present disclosure, which modifications would be within the scope of the present technology.

1. A method for controlling operation of an engine using an engine controller, the method comprising:
setting a status of the controller at an initial state;
receiving pilot input for control of the engine and obtaining one or more engine parameters;
updating the status of the controller according to engine specific requirements based on at least one of the pilot input and the one or more engine parameters, the engine specific requirements defining conditions for transitioning the status of the controller for the engine; and
controlling operation of the engine based on the status of the controller, the pilot input, and the one or more engine parameters.

2. The method of claim 1, wherein updating the status of the controller comprises:
determining a transition command from the engine specific requirements based on at least one of the pilot input and the one or more engine parameters; and
setting the status in a state machine of the controller based on the transition command.

3. The method of claim 2, wherein the transition command corresponds to one of: a start command, a shutdown command and a start complete command.

4. The method of claim 1, wherein the status of the controller corresponds to one of: engine off, engine starting, engine running and engine shutting down.

5. The method of claim 1, wherein the controller operates with an active channel and a passive channel, and wherein the method is performed in the active channel.

6. The method of claim 5, further comprising synchronizing the status of the controller between the active channel and the passive channel in response to a channel switchover.

7. The method of claim 6, wherein synchronizing the status of the controller comprises:
determining an expected controller status based on previously received pilot input;
detecting a synchronization error when the expected controller status differs from the status of the controller; and
modifying the status of the controller in response to detecting the synchronization error.

8. The method of claim 7, wherein modifying the status of the controller comprises setting the status of the controller to the expected controller status.

9. The method of claim 7, wherein detecting the synchronization error comprises detecting the synchronization error when the expected controller status differs from the status of the active channel and the expected controller status differs from the status of the passive channel.

10. The method of claim 9, wherein modifying the status of the controller comprises setting the status of the active channel to the expected controller status or to the status of the passive channel.

11. A system for controlling operation of an engine using an engine controller, the system comprising:
a processing unit; and
a non-transitory memory communicatively coupled to the processing unit and comprising computer-readable program instructions executable by the processing unit for:
setting a status of the controller at an initial state;
receiving pilot input for control of the engine and obtaining one or more engine parameters;
updating the status of the controller according to engine specific requirements based on at least one of the pilot input and the one or more engine parameters, the engine specific requirements defining conditions for transitioning the status of the controller for the engine; and
controlling operation of the engine based on the status of the controller, the pilot input, and the one or more engine parameters.

12. The system of claim 11, wherein updating the status of the controller comprises:
determining a transition command from the engine specific requirements based on at least one of the pilot input and the one or more engine parameters; and
setting the status in a state machine of the controller based on the transition command.

13. The system of claim 12, wherein the transition command corresponds to one of: a start command, a shutdown command and a start complete command.

14. The system of claim 11, wherein the status of the controller corresponds to one of: engine off, engine starting, engine running and engine shutting down.

15. The system of claim 11, wherein the controller operates with an active channel and a passive channel, and wherein the method is performed in the active channel.

16. The system of claim 15, wherein the computer-readable program instructions are further executable by the processing unit for synchronizing the status of the controller between the active channel and the passive channel in response to a channel switchover.

17. The system of claim 16, wherein synchronizing the status of the controller comprises:
determining an expected controller status based on previously received pilot input;
detecting a synchronization error when the expected controller status differs from the status of the controller; and
modifying the status of the controller in response to detecting the synchronization error.

18. The system of claim 17, wherein modifying the status of the controller comprises setting the status of the controller to the expected controller status.

19. The system of claim 17, wherein detecting the synchronization error comprises detecting the synchronization error when the expected controller status differs from the status of the active channel and the expected controller status differs from the status of the passive channel.

20. The system of claim 19, wherein modifying the status of the controller comprises setting the of the active channel to the expected controller status or to the status of the passive channel.
